(19) United States
(12) Patent Application Publication
(10) Pub. No.: US 2022/0333818 A1
(43) Pub. Date: Oct. 20, 2022

(54) HEAT EXCHANGER WITH THICK-FILM RESISTOR

(71) Applicant: MAHLE International GmbH, Stuttgart (DE)

(72) Inventors: Stefan Bögershausen, Stuttgart (DE); Francisco González Espin, Valencia (ES); Torbjorn Hallberg, Valencia (ES); Christoph Walter, Stuttgart (DE); Robin Wanke, Stuttgart (DE)

(21) Appl. No.: 17/720,341

(22) Filed: Apr. 14, 2022

(30) Foreign Application Priority Data
Apr. 15, 2021 (EP) 21168506.0

(51) Int. Cl. F24H 1/10; H05B 3/46

(52) U.S. Cl. CPC F24H 1/102; H05B 3/46; H05B 2203/013; H05B 2203/017

(57) ABSTRACT

A heat exchanger for heating a fluid that exhibits simplified manufacturing, a reduced construction size, and/or an increased heating efficiency. The heat exchanger has at least two distanced tube bodies through which a flow path of the fluid leads. A thin-film resistor is applied on the outer surface of at least one of the tube bodies with an interface made of a thermal interface material located between the thick-film resistor and the next neighboring tube body.

### CROSS REFERENCE TO RELATED APPLICATIONS

This application claims the benefit of priority under 35 U.S.C. § 119 to European Patent Application No.: 21168506.0, filed Apr. 15, 2021, the contents of which is incorporated herein by reference in its entirety.

### FIELD

The invention relates to a heat exchanger for heating a fluid, such as for example, a coolant. The heat exchanger comprises tube bodies and at least one thick-film resistor.

### BACKGROUND

The statements in this section merely provide background information related to the present disclosure and several definitions for terms used in the present disclosure and may not constitute prior art.

For heating a fluid with a heat exchanger, the fluid usually flows through the heat exchanger. Within the heat exchanger, heat is transferred to the fluid in order to heat the fluid. In generic heat exchangers, heat is generated by the consumption of electric power.

For this purpose, positive temperature coefficient elements, also known as PTC elements are used. Corresponding heat exchangers typically comprise tube bodies, which delimit a flow path of the fluid to be heated. The PTC elements are connected to the tube bodies in a heat-transferring manner, thereby, in operation, heating the fluid flowing through the tube bodies. In most applications, the PTC elements are arranged outside the tube bodies, in particular for the protection of the PTC elements and/or for avoiding electric interaction of the PTC elements with the fluid.

These heat exchangers are usually manufactured by arranging single PTC elements, commonly in a successive manner, on a corresponding tube body. This leads to a complicated and expensive manufacture of the heat exchangers.

Due to the temperature dependency of their electrical resistance PTC elements are appreciated for their heating behavior. However, the temperature dependent electrical resistance undergoes a minimal resistance at a so-called critical temperature. This behavior leads to a peak of current flowing through the PTC element at the critical temperature. This peak corresponds to a considerable or large load for the electric components of the heat exchanger and/or neighboring components and can lead to their failure.

Alternative electric heating elements, such as thick-film resistors may be used because of their availability and their cost-effective production. A corresponding heat exchanger might comprise a single tube body on which a thick-film resistor is arranged. Such a heat exchanger, however, is expensive and comprises a low efficiency.

As an alternative, the heat exchanger may comprise several tube bodies. In such a heat exchanger, a corresponding thick-film resistor could be arranged on each tube body. This, however, leads to a complicated and complex manufacture of the heat exchanger. Moreover, the construction size is rather large and/or the heating efficiency is rather low.

### SUMMARY

The objective of the present disclosure is to remedy the aforementioned disadvantages and to provide an improved, or at least an alternative, form of embodiment of a heat exchanger for heating a fluid, which is in particular characterized by a simplified manufacture and/or a reduced construction size and/or an increased heating efficiency.

This objective is achieved with a heat exchanger comprising at least two tube bodies with each tube body extending in an extension direction and being enclosed in a circumferential direction. Each tube body delimits a flow path of the fluid along the extension direction. The tube bodies are distanced from another in a distance direction transverse to the extension direction. A thick-film resistor is applied on an outer surface of at least one of the at least two tube bodies. An interface made of a thermal interface material is arranged between the thick-film resistor and the outer surface of the next neighboring tube body and connects the thick-film resistor to the next neighboring tube body in a heat transferring manner. The objective is further achieved by various advantageous forms of the heat exchanger described above as further defined herein.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawing, in which:

FIG. 1 shows a highly simplified, schematic-type view of a cycle with a heat exchanger; and

FIG. 2 shows a sectional view through the heat exchanger

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate identical, similar or functionally equivalent parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The present disclosure is based on the general concept of, in a heat exchanger for heating a fluid, providing at least two tube bodies through which the fluid flows and of applying a thick-film resistor on the outer surface of at least one of the tube bodies and connecting the thick-film resistor to the next neighboring tube body in a heat transferring manner. By applying the thick-film resistor to the surface of the corresponding tube body, measures for connecting the thick-film resistor to the tube body are omitted. This leads to an improved heat transfer from the thick-film resistor to the tube body and thus to the fluid. Moreover, by connecting the thick-film resistor to the next neighboring tube body in a heat transferring manner, heat is also transferred to the next neighboring tube body and hence to the fluid flowing through the tube body. These lead to an improved heating efficiency of the heat exchanger. In addition, by applying the thick-film resistor on the corresponding tube body, the arrangement and alignment of single thick-film resistor elements are avoided. This leads to a considerable simplification of the manufacture of the heat exchanger. Furthermore, the construction size of the heat exchanger is reduced.

In accordance with the general concept of the present disclosure the heat exchanger, in operation, heats the fluid. The fluid, in operation, flows through the at least two tube bodies. The heat exchanger thus comprises at least two tube bodies. Each tube body extends in a direction in which the fluid flows through the tube body. This direction is also referred to as extension direction in the following. Each tube body is further circumferentially enclosed and thus in circumferential direction. As a result, each tube body delimits a flow path of the fluid along the extension direction. The tube bodies are distanced to another transverse to the extension direction. That is, the tube bodies are distanced to another in a distance direction transverse to the extension direction. On at least one of the tube bodies a corresponding thick-film resistor is applied. For example, a thick-film resistor may be applied on an outer surface of at least one of the at least two tube bodies. The thick-film resistor is further thermally connected to the next neighboring tube, wherein the thermal connection is achieved by a thermal interface material. An interface made of thermal interface material is, on the side of the thick-film resistor averted from the corresponding tube body, arranged between the thick-film resistor and the outer surface of the next neighboring tube body and connects the thick-film resistor to the next neighboring tube body in a heat transferring manner.

According to one aspect of the present disclosure, in operation, the at least one thick-film resistor is electrically supplied and generates heat. The heat exchanger is therefore an electric heat exchanger.

According to another aspect of the present disclosure, inn operation, the fluid flows along the flow path through the tube bodies, wherein heat is transferred to the fluid from the at least one thick-film resistor via the tube bodies.

Applying the thick-film resistor on the corresponding tube body, in particular, means that the thick-film resistor is deposited on the outer surface of the corresponding tube body.

At least one of the at least one thick-film resistors is advantageously applied directly on the outer surface of the corresponding tube body. This leads to an improved heat transfer from the thick-film resistor to the corresponding tube body and thus to the fluid and hence and improved efficiency. In addition, the manufacture of the heat exchanger is simplified.

According to another aspect of the present disclosure, at least one of the at least one thick-film resistors is printed on the corresponding tube body. This leads to a simpler manufacture of the heat exchanger. As an alternative, it is possible to spray or sinter at least one of the at least one thick-film resistors on the corresponding tube body.

At least one of the at least two tube bodies may be advantageously made of a metal or an alloy. This leads to improved thermal conductivity of the tube body and thus an improved heat transfer from the at least one thick-film resistor to the fluid.

Moreover, the corresponding thick-film resistor may be applied on the tube body in a simple and cost-efficient way. According to another aspect of the present disclosure, at least one of the at least two tube bodies may be made of aluminum or an aluminum alloy.

Each tube body can generally have an arbitrary shape. It is for instance possible that at least one of the at least two tube bodies has a circular shape and/or cross section.

Alternatively, at least one of the at least two tube bodies is a flat tube. The tube body thus has two opposing flat sides. This leads to a reduced construction size of the heat exchanger. A flat tube further allows a simplified and large-scale application of the thick-film resistor on the flat sides of the tube body. It may be advantageous, if at least one of the at least one thick-film resistors is applied on the flat side of the corresponding flat tube. For example, the thick-film resistor may be applied on at least one of the flat sides. Alternatively, the thick-film resistor may be applied only on one of the flat sides.

Each flat tube may be manufactured in an arbitrary manner. For instance the flat tube may be extruded, brazed, welded, die-casted or the like.

Each thick-film resistor can in general be of any kind known by the skilled person. Each thick-film resistor advantageously comprises two or more layers. According to one aspect of the present disclosure at least one of the at least one layers is a dielectric layer. Each thick-film resistor advantageously has a substantially even thickness along the extension direction.

The distanced arrangement of the at least two tube bodies in distance direction leads to a gap between the next neighboring tube bodies. According to one aspect of the present disclosure, each gap may be filled by the interface and one such thick-film resistor.

The thermal interface material is in particular known to the skilled person as “TIM”. The thermal interface material can generally be of any kind, provided that it improves the thermal conductivity between the corresponding thick-film resistor and the next neighboring tube body which is the tube body corresponding to the interface. The thermal interface material may be electrically isolating. This can be achieved by providing the thick-film resistor with at least one dielectric layer. In a variant, the isolation can be partially or completely achieved by designing the thermal interface material itself isolating.

According to another aspect of the present disclosure, the interface is arranged between the corresponding thick-film resistor and the corresponding tube body. For example, the interface may be in contact with the corresponding thick-film resistor and the corresponding tube body.

The thermal interface material and thus the interface is advantageously insulating, that is an electric insulator. The thermal interface material may comprise a silicone and/or is a silicone.

The manufacture of the heat exchanger may be simplified and the heat transfer improved, if the interface is potted between the corresponding thick-film resistor and the next neighboring tube body. As an alternative, the interface may be applied as an isolation foil or the like.

When desirable, a thick-film resistor may be applied on each of the at least two tube bodies.

According to one aspect of the present disclosure, the heat exchanger may comprise three or more tube bodies, wherein one of the tube bodies is free of thick-film resistors. That is, the heat exchanger comprises a total number of N tube bodies, wherein N is equal to or larger than three. On N−1 of the tube bodies such a thick-film resistor is applied and one of the tube bodies is free of thick-film resistors.

In another embodiment of the present disclosure, along the distance direction, a thick-film resistor is applied on every other tube body. That is, along the distance direction a thick-film resistor is alternatingly applied on the tube bodies. This in particular means that, if the heat exchanger comprises two tube bodies, a thick-film resistor is applied on only one of the tube bodies. The thick-film resistor is appropriately applied to the side of the corresponding tube body which faces the neighboring tube body.

According to yet another embodiment of the present disclosure, the heat exchanger comprises three tube bodies distanced to another in distance direction. The heat exchanger thus comprises two outer tube bodies and a center tube body arranged between the two outer tube bodies in distance direction. Preferably, on each of the outer tube bodies a corresponding thick-film resistor is applied, whereas no thick-film resistor is applied to the center tube body. That is, the center tube body is free of thick-film resistors. Appropriately, each thick-film resistor is applied on the side of the corresponding outer tube body, which faces the center tube body. Moreover, an interface is arranged between each of the thick-film resistors and the center tube body. In this way, by using two thick-film resistors three tube bodies are heated. Thus, the heat exchanger has a size and cost reduced design. At the same time, the heat exchanger comprises an improved efficiency.

According to another aspect of the present disclosure, the heat exchanger is designed in a manner that, in operation, over 50%, alternatively, two-thirds (⅔), of total transferred heat of each thick-film resistor is transferred to the corresponding tube body, that is the corresponding outer tube body, and less than 50%, alternatively, one-third (⅓), is transferred to the center tube body. As a result, each of the tube bodies receives an equal ratio of the total transferred heat. Hence, the fluid is heated homogenously. The homogenous heating is improved by the provision of equal thick-film resistors. The homogenous heating can be further improved by equal thick-firm resistors and/or equal tube bodies.

The mentioned different heat transfer rates can be achieved by any measure. In general, the heat transfer ratio can be adjusted by adapting the thickness and/or material of the interface. For instance, it is possible to choose an according thickness and/or heat transfer coefficient.

Each of the at least one interfaces can have any thickness along the distance direction. Alternatively, at least one of the at least one interfaces has a thickness of between 50 μm and 300 μm, alternatively, between 100 μm and 250 μm, for example, between 150 μm and 250 μm, alternatively, between 175 μm and 225 μm, for example 200 μm. These ranges of thickness in particular lead to the advantageous heat transfer ratios of the thick-film resistor to the corresponding tube body and the next neighboring tube body.

The heat transfer ratio can, in an alternative or additional manner, be adjusted by applying a material with a reduced heat transfer coefficient. This allows to use a thinner interface. By doing so, the thickness of the interface can be reduced. As a result, the interface can comprise a smaller thickness, e.g. 50 μm.

The heat exchanger may be used for heating any fluid. The heat exchanger can for example be used to heat air, wherein the heated air can be supplied to a subsequent application. The heat exchanger can for instance be part of an air conditioner. The heat exchanger may also be used for heating a coolant, for example, in a vehicle and/or an air conditioner and/or a traction battery.

Further important characteristics and advantages of the invention are now described with associated description of the figures, with reference to the drawings. It is understood that the above-mentioned characteristics, and those to be described hereinafter, are not only applicable in the respective combination indicated, but also in other combinations, or in isolation, without departing from the scope of the present invention.

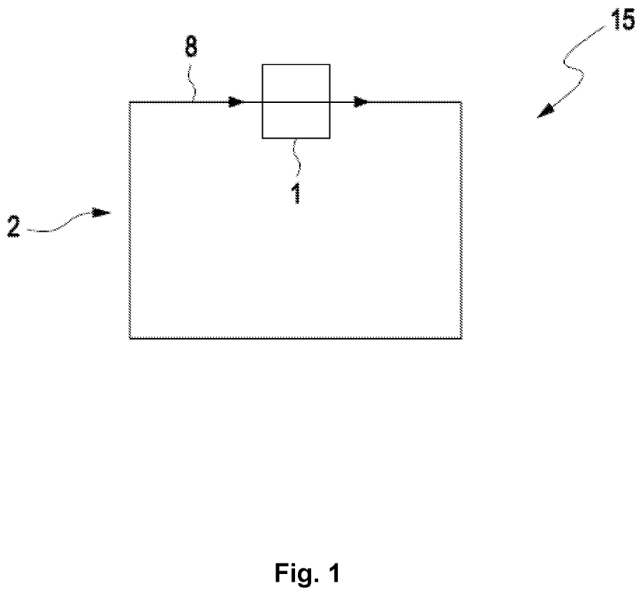

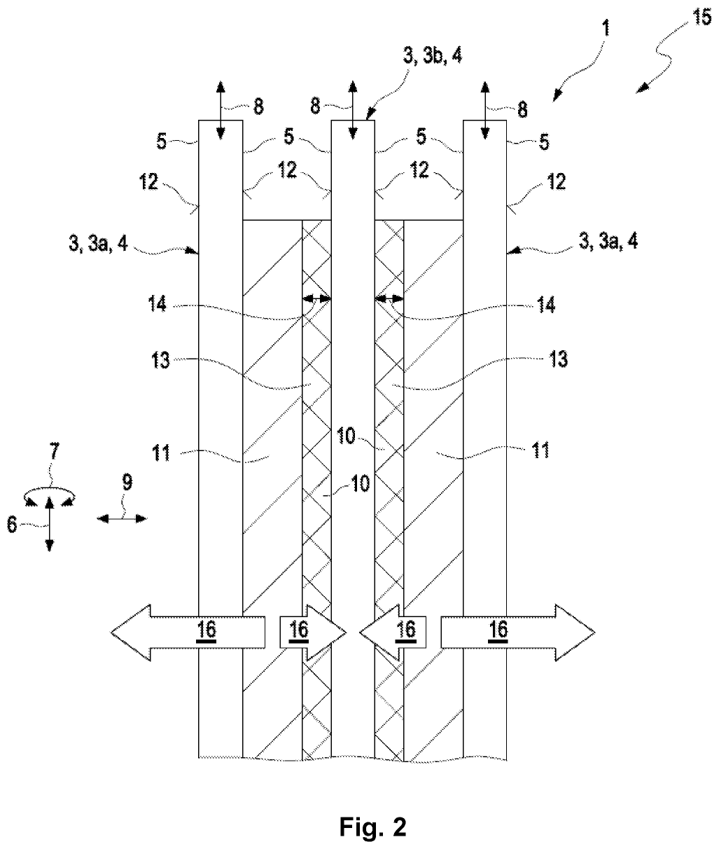

A heat exchanger 1, as shown in FIGS. 1 and 2 by way of example, can be part of a cycle 2, which is shown in FIG. 1 by way of example. The heat exchanger 1 serves to heat a fluid. In the embodiments depicted in the figures, the heat exchanger 1, in operation, heats a coolant as fluid. The fluid circulates through the cycle 2. The cycle 2 might comprise a pump (not shown) for this purpose. The cycle 2 and/or the heat exchanger 1 can be part of an otherwise not shown vehicle 15.

As can be seen in FIG. 2, the heat exchanger 1 comprises at least two tube bodies 3 through which the fluid flows. As shown in the figure, the heat exchanger 1 comprises a total of three tube bodies 3, wherein the tube bodies 3 are identical. Each tube body 3 is a flat tube 4 with two opposing flat sides 5. Each tube body 3 might be made of metal or an alloy, such as, without limitation, aluminum or an aluminum alloy. Each tube body 3 extends in a direction 6, in which the tube body 3 is configured to allow the fluid to flow through. This direction is also referred to as extension direction 6 in the following. Thus, each tube body 3 extends in extension direction 6 and is enclosed in a circumferential direction 7 and thereby delimits a flow path 8 of the fluid along the extension direction 6. The tube bodies 3 are distanced to another transverse to the extension direction 6 and thus in a direction 9 transverse to the extension direction 6, wherein this direction 9 is also referred to as distance direction 9 in the following. The heat exchanger 1, in the embodiment shown in FIG. 2, thus comprises, in distance direction 9, two outer tube bodies 3a and one center tube body 3b arranged between the outer tube bodies 3a. The tube bodies 3 are arranged such that flat sides 5 of the tube bodies 3 follow each other in distance direction 9. Due to the distanced arrangement of the tube bodies 3 a gap 10 is arranged between the neighboring tube bodies 3.

According one aspect of the present disclosure, a thick-film resistor 11 is applied on an outer surface 12 of at least one of the at least two tube bodies 3. The thick-film resistor 11 is for instance printed or sprayed on the corresponding tube body 3. In addition, an interface 13 made of a thermal interface material is, on the side of the thick-film resistor 11 averted from the corresponding tube body 3, arranged between the thick-film resistor 11 and the outer surface 12 of the next neighboring tube body 3. The interface 13 connects the thick-film resistor 11 to the next neighboring tube body 3 in a heat transferring manner. The thermal interface material can be electrically insulating, such as for example, without limitation, a silicone.

In the embodiment shown in FIG. 2, the respective thick-film resistor 11 is directly applied on the outer surface 12 of the corresponding tube body 3. Each of the thick-film resistor 11 can comprise two or more layers (not shown), wherein at least one of the layers can be dielectric.

According to another aspect of the embodiment shown in FIG. 2, the respective thick-film resistor 11 is only applied on the outer surface 12 of the outer tube bodies 3a. Thus, in distance direction 9, every second tube body 3 is applied with such a thick-film resistor 11. Thus, the number of tube bodies 3 on which a thick-film resistor 11 is applied is one less than the total number of tube bodies 3. That is, the heat exchanger 1 comprises a total number of three tube bodies 3, wherein on two of the tube bodies 3 such a thick-film resistor 11 is applied and one of the tube bodies 3 is free of thick-film resistors 11.

According to another aspect of the embodiment shown in FIG. 2, on each outer tube body 3a, the corresponding thick-film resistor 11 is solely applied on the outer surface 12 of the flat side 5 facing the center tube body 3b. In addition, in the embodiment shown in FIG. 2, such an interface 13 is arranged between each thick-film resistor 11 and the flat side 5 of the center tube body 3b. Each of the interfaces 13 can be potted between the corresponding flat side 5 of the center tube body 3b and the corresponding thick-film resistor 11. Thus, each gap 10 is filled with corresponding interface 13. In FIG. 2, the interfaces 13 and the thick-film resistors 11 are identical, respectively. Further in FIG. 2, the tube bodies 3, in extension direction 6, project the interfaces 13 and the thick-film resistors 11. That is, the tube bodies 3 are, in extension direction 6, longer than the interfaces 13 and the thick-film resistors 11.

Each interface 13 extends in distance direction and thus comprises a thickness 14 (see FIG. 2). The thickness 14 of each interface 13 is advantageously between 50 μm and 300 μm, for example, 200 μm or 0.2 millimeters (mm), wherein the interfaces 13 are shown exaggerated relative to the tube bodies 3 for comprehensive reasons. The thick-film resistors 11 might have thicknesses (not shown) similar to the interfaces 13.

Each of the thick-film resistors 11, in operation and thus when electrically supplied, generates heat. This heat is directly transferred to corresponding tube body 3. The heat if further transferred to the next neighboring tube body 3 via the corresponding interface 13. As indicated by thick arrows 16 in FIG. 2, the heat exchanger 1 is shown designed in a manner that the ratio of heat transferred from each thick-film resistor 11 to the corresponding tube 3 to the heat transferred to the next neighboring tube body 3 via the interface 13 is substantially more than 2:1 (two to one). Thus, more than 50% of the total transferred heat of each thick-film resistor 11 is transferred to the corresponding tube body and less than 50% of the total heat, via the interface 13, is transferred to the next neighboring tube body 3. According to another aspect of the embodiment shown in FIG. 2, substantially ⅔ (two-thirds) of the generated heat of each thick-film resistor 11 may be transferred to the corresponding outer tube body 3a and substantially ⅓ (one-third) to the center tube body 3b via the corresponding interface 13. This results in a substantially homogenous heat transfer to each tube body 3 and thus a homogeneous heating of fluid flowing through each tube body 3.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A heat exchanger for heating a fluid, in particular for heating a coolant, the heat exchanger comprising
at least two tube bodies, wherein each tube body extends in an extension direction and is enclosed in a circumferential direction, each tube body delimits a flow path of the fluid along the extension direction, the tube bodies are distanced to another in a distance direction transverse to the extension direction,
at least one thick-film resistor applied on an outer surface of at least one of the at least two tube bodies, and
at least one interface made of a thermal interface material arranged between the thick-film resistor and the outer surface of the next neighboring tube body, the at least one interface connecting the thick-film resistor to the next neighboring tube body in a heat transferring manner.

2. The heat exchanger according to claim 1, wherein along the distance direction, the thick-film resistor is applied on every second tube body.

3. The heat exchanger according claim 1, wherein the heat exchanger comprises three tube bodies such that a center tube body is arranged between two outer tube bodies,
wherein on each of the outer tube bodies the thick-film resistor is applied,
wherein the center tube body is free of the thick-film resistor,
wherein the interface is arranged between each of the thick-film resistors and the center tube body.

4. The heat exchanger according to claim 3, wherein the heat exchanger is configured such that, in operation, over 50% of total transferred heat of each thick-film resistor is transferred to the corresponding outer tube body and less than 50% is transferred to the center tube body.

5. The heat exchanger according to claim 4, wherein the heat exchanger is configured such that, in operation, ⅔ of total transferred heat of each thick-film resistor is transferred to the corresponding outer tube body and ⅓ is transferred to the center tube body.

6. The heat exchanger according to claim 1, wherein one or more of the at least one interface has a thickness running in distance direction of between 50 μm and 300 μm.

7. The heat exchanger according to claim 1, wherein one or more of the at least one thick-film resistor is applied on the side of the corresponding tube body facing the next neighboring tube body.

8. The heat exchanger according to claim 1, wherein one or more of the at least two tube bodies is a flat tube.

9. The heat exchanger according to claim 8, wherein one or more of the at least one thick-film resistor is applied on a flat side of the flat tube.

10. The heat exchanger according to claim 1, wherein one or more of the at least one thick-film resistor is printed, sintered, or sprayed onto the tube body.

11. The heat exchanger according to claim 1, wherein one or more of the at least one thick-film resistor is directly applied on the tube body.

12. The heat exchanger according to claim 1, wherein one or more of the at least two tube bodies is made a metal or an alloy.

13. The heat exchanger according to claim 1, wherein one or more of the at least one thick-film resistor has at least two layers including at least one dielectric layer.

14. The heat exchanger according to claim 1, wherein one or more of the at least one interface comprises a silicone.

15. The heat exchanger according to claim 1, wherein one or more of the at least one interface is potted between the corresponding thick-film resistor and the next neighboring tube body.

16. The heat exchanger according to claim 1, wherein the heat exchanger comprises a total number of N tube bodies, with N being equal to or larger than three, wherein on N−1 of the tube bodies, the thick-film resistor is applied and one of the tube bodies is free of the thick-film resistor.
